(19) United States
(12) Patent Application Publication
(10) Pub. No.: US 2026/0271906 A1
(43) Pub. Date: Sep. 17, 2026

(54) HOOF BOOT

(71) Applicant: TBROADBRIDGE LTD, Lamerton (GB)

(72) Inventor: Thomas Broadbridge, Lamerton (GB)

(21) Appl. No.: 19/659,526

(22) Filed: Apr. 27, 2026

Related U.S. Application Data
(63) Continuation-in-part of application No. PCT/GB2024/052749, filed on Oct. 28, 2024.

(30) Foreign Application Priority Data
Oct. 31, 2023 (GB) 2316642.4

(51) Int. Cl. A01L 1/04; A01L 3/00; A01L 7/02

(52) U.S. Cl. CPC A01L 1/04; A01L 3/00; A01L 7/02

(57) ABSTRACT

A hoof boot having a front shell and a removably attached heel captivator. The front shell comprises an upper portion for receiving the front of a horse's hoof, in use, and a sole plate. The upper portion of the front shell is physically coupled to the outer edge of the sole plate. The sole plate and upper portion of the front shell are formed of a resiliently flexible material. The front shell has at least one slot or recess that extends from an upper edge of the upper portion and along at least a portion of its height. The sole plate has at least two slots or recesses that extend generally radially from a central region of the sole plate along at least a portion of its width.

### CROSS-REFERENCE TO RELATED APPLICATIONS

This application is a bypass continuation of PCT International Application PCT/GB2024/052749, filed on Oct. 28, 2024, which claims the benefit of, or priority to, United Kingdom Patent Application GB2316642.4, filed on Oct. 31, 2023, both of which are hereby incorporated by reference in their entirety.

### FIELD OF THE INVENTION

This invention relates generally to a hoof boot for a horse, designed to accommodate different-sized and shaped horses' hooves, and also to a kit of parts including a such a hoof boot.

### BACKGROUND OF THE INVENTION

Hoof boots are used to protect the hooves of a horse, and are often used instead of horseshoes. Hoof boots most commonly consist of a sock-like upper, usually formed of a waterproof, often elastic, textile based on polyurethane or similar, and an integrated rubber sole at the foot of the upper. As the upper and sole are fixed together, the upper usually has some means (e.g. a zip) to allow the upper to be opened sufficiently to allow a horse's hoof to slip into the hoof boot and rest against the sole at the foot of the upper. The upper can then be fastened such that it completely covers the hoof wall and often also at least a portion of the fetlock above.

Horse hoof sizes and shapes vary greatly and, since conventional hoof boots of the type described above have a fixed sole and upper, it is necessary to supply them in a range of sizes from which a consumer can select the size that most closely matches their own horse's hoof. However, even if the correct size (according to the respective sizing convention) is selected, it s unlikely to precisely match the shape of a particular horse's hoof: it is likely to be slightly too large in any or all dimensions. This, in turn, can cause the horse's hoof to slip or twist within the hoof boot, and cause discomfort and/or injury to the horse.

Adjustable hoof boots have been proposed to address this issue, although they are not in common usage in the field. One such adjustable hoof boot is described in US Patent Application Publication No. US2019/364848. The hoof boot described in this document consists of a two-part hoof boot having a front shell and a heel support, with the heel support being coupled to the front shell via a base plate that extends between the two parts, along the bottom of the hoof boot. The front shell has a sole with an integral side wall forming a recess into which the front portion of a horse's hoof can be slotted. The heel support essentially consists of a generally C-shaped cradle that, in use, extends around the back of a horse's fetlock, with each end of the heel cradle resting near a respective side of the horse's fetlock. The base plate is coupled, at one end, to the heel cradle, and at the other end, slidably coupled to the base of the front shell. The base plate can thus be used to adjust the distance (front to back) between the heal cradle and the front shell and, therefore, the size of the hoof boot in that dimension. The heel cradle and base plate are coupled together by a hinge such that the heel cradle can be moved downward to allow a horse's hoof to be inserted in the recess defined by the front shell, and then pivoted upwardly so that it extends around the back of the horse's fetlock, where it can be secured by a pair of adjustable straps, each strap extending from a respective end of the heel cradle to a central location on the upper edge of the side wall of the front shell.

However, the adjustment offered in the hoof boot described above is only in one dimension (along an axis defined between the front and rear of the horse's hoof), and does not offer any means for adjusting the shape along any other axis or dimension, nor does it offer any means of adjusting the internal shape of the hoof boot. As such, this hoof boot would suffer many of the same disadvantages associated with the more conventional hoof boots, as described above. Clearly, then, there is a desire to provide a hoof boot that can provide an improved ‘fit’ for multiple different hoof shapes, and aspects of the present invention seek to address at least one or more of these issues.

### SUMMARY OF THE INVENTION

In accordance with a first aspect of the invention, there is provided a hoof boot comprising a front shell and a removably attached heel captivator, the front shell comprising an upper portion defining a recess for receiving the front of a horse's hoof, in use, and the heel captivator being configured, in use, to retain and support the rear of a horse's hoof, the front shell further comprising a sole plate, said upper portion of said front shell being physically coupled to a portion of an outer edge of the sole plate, the sole plate and upper portion of the front shell being formed of a resiliently flexible material, wherein at least one first slot or recess is provided in the front shell, the or each first slot or recess extending from an upper edge of the upper portion of the front shell and along at least a portion of its height, and the sole plate has at least two second slots or recesses therein, each second slot or recess extending generally radially from a central region of said sole plate along a portion of a width thereof.

In an embodiment, at least two first slots or recesses may be provided in the front shell, each first slot or recess being located at the front of the upper portion, when oriented for normal use, and each first slot or recess being located at an equal distance from the centre thereof.

Beneficially, the or each first slot or recess may be generally V-shaped, the widest end thereof being located at the upper edge of the upper portion of the front shell, and the apex thereof being located near an edge of the sole plate.

The front and side edges of the sole plate, when oriented for normal use, may, at least in some embodiments, be substantially oval, and the rear of the sole plate may have a generally V-shaped recess therein, the widest end of said V-shaped recess being located at the outer edge of the sole plate.

Optionally, the sole plate may have a generally central opening or recess therein, defining said central region, and said at least two second slots or recesses may extend generally radially from said opening along a portion of the width of the sole plate. The central opening may be generally triangular.

In at least some embodiments, at least two pairs of second slots of recesses may be provided in the sole plate, each slot or recess of a respective pair extending from a respective side of said central region along a portion of the width of the sole plate.

Beneficially, at least one of said second slots or recesses may extend along the longitudinal axis of the sole plate.

Beneficially, a bottom surface of said sole plate is provided with a tread layer, and said second slots or recesses may extend through at least a portion of said tread layer.

In a preferred embodiment, the sole plate may further comprise a removable in-sole comprising a hoof plate that has a first substantially planar surface and a protruding insert portion on the opposing second surface, said protruding insert portion being shaped and configured to fit into said generally central opening or recess in said sole plate. Additionally or alternatively, the sole plate may comprise a protruding insert portion on the opposing second surface, said protruding insert portion being shaped and configured to fit into said V-shaped recess in said sole plate. Beneficially, the in-sole may be configured to be cut and/or trimmed to any desired shape or size prior to mounting it on said sole plate.

In a preferred embodiment, the heel captivator may comprise a generally C-shaped heel cradle having a pair of distal ends, the heel cradle comprising a pair of side-by-side heel bulb receiving portions integrally coupled together by a central portion, each heel bulb receiving portion comprising a concave plate shaped and configured such that, in use, an upper edge thereof can engage with the radius of a respective heel bulb of a horse's hoof.

Beneficially, the heel captivator may further comprise a removably attached central post, wherein a protruding connecting member is provided at the rear of the heel captivator, at said central portion, said connecting member being configured to removably receive and retain an elongate central post via a first aperture along its length. The central post may comprise a plurality of first apertures along its length.

In at least some embodiment, a pair of protruding connecting members may be provided at the rear of the sole plate, and the central post may then comprise a pair of second apertures at its base for removably attaching said central post to the front shell via said connecting members.

Beneficially, the upper portion of said front shell and said heel captivator may comprise means for receiving and retaining one or more attachment straps for coupling said heel captivator to said front shell, in use.

These and other aspects of the invention will be apparent from the following detailed description.

### BRIEF DESCRIPTION OF THE DRAWINGS

An embodiment of the present invention will now be described, by way of example only, and with reference to the accompanying drawings, in which:

FIG. 1A is a schematic plan view of a hoof boot according to an exemplary embodiment of the invention, with the heel captivator and front shell disengaged from each other;

FIG. 1B is a schematic plan view of the front shell of the hoof boot of FIG. 1A, illustrating the central opening and slots in the sole plate more clearly;

FIG. 2 is a schematic front view of the hoof boot of FIG. 1A;

FIG. 3A is schematic bottom view of the hoof boot of FIG. 1A;

FIG. 3B is a schematic bottom view of the hoof boot of FIG. 1A, illustrating the central opening and slots in the sole plate more clearly;

FIG. 4 is a schematic front perspective view of the hoof boot of FIG. 1A;

FIG. 5 isa schematic rear perspective view of the hoof boot of FIG. 1A, with the heel captivator engaged with the front shell, but omitting the attachment straps;

FIG. 6 is a schematic side view of the hoof boot of FIG. 5;

FIG. 7 is a schematic rear view of the hoof boot of FIG. 5;

FIG. 8 is a schematic plan view of an in-sole for a hoof boot according to an exemplary embodiment of the invention;

FIG. 9 is a schematic bottom view of the in-sole of FIG. 8; and

FIG. 10 is a schematic side view of the in-sole of FIG. 8.

### DETAILED DESCRIPTION OF THE INVENTION

In the following description of various exemplary embodiments of the invention, reference is made to the accompanying drawings that form a part hereof, and in which are shown, by way of examples and illustration, specific embodiments in which the invention may be practiced. These embodiments are described in sufficient detail to enable those skilled in the art to practice the invention, and it is to be understood that other embodiments may be utilized and that variations and modifications may be made, without departing from the scope of the invention as defined in the appended claims. The following detailed description is therefore not to be taken in a limited sense.

The specification may refer to “an”, “one” or “some” embodiment(s) in some parts. This does not necessarily imply that each such reference is to the same embodiment(s), or that the feature applies to only one embodiment. Single features of different embodiments may also be combined to make another embodiment.

As used herein, the singular forms “a”, “an” and “the” are intended to include the plural forms as well, unless expressly stated otherwise. It will be further understood that the terms “includes”, “comprises”, “including” and/or “comprising”, when used in this specification, specify the presence of stated features, integers, steps, operations, elements and/or components, but do not preclude the presence or addition of one or more other features, integers, operations, steps, elements, components and/or groups thereof As used herein, the term “and/or” includes any and all combinations and arrangements of one or more of the associated listed items.

Directional descriptors such as upper, lower, left, right, clockwise, anti-clockwise, front, rear and other similar adjectives are used for clarity and refer to the orientation of the invention as illustrated in the drawings, however it will be clear to those skilled in the art that the invention may not always be oriented as illustrated and the invention is not intended to be limited in this regard.

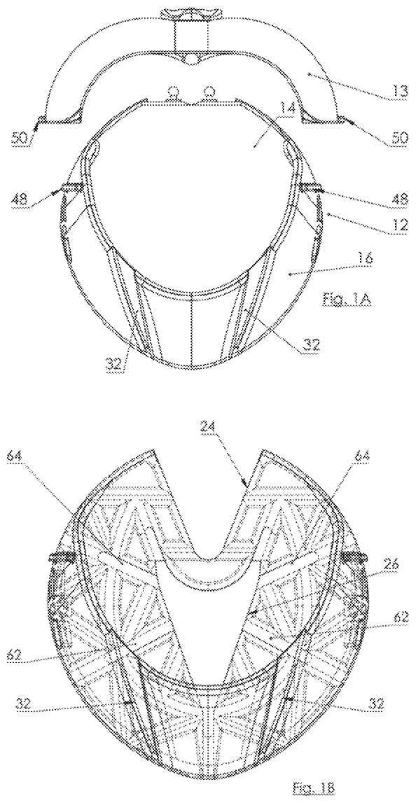

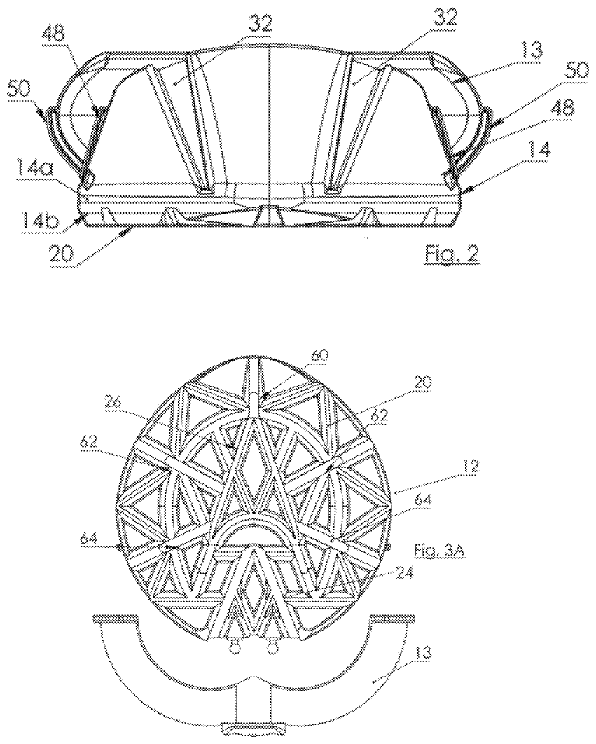

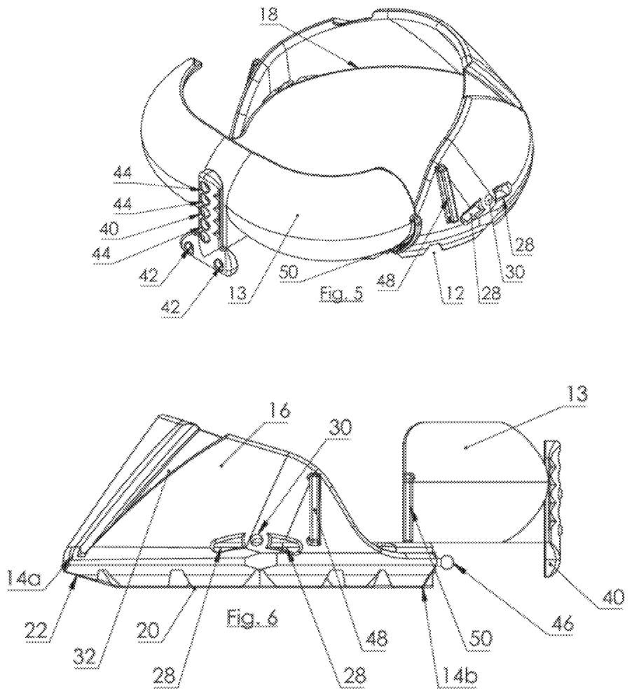

Referring to FIGS. 1A to 7 of the drawings, an example hoof boot comprises a front shell 12 and a rear heel captivator 13. The front shell 12 comprises a sole plate 14 at its base, and an integral side wall 16 extending upwardly from the peripheral edges of the sole plate 14, at an acute angle to the plane of the sole plate 14, to form a recess 18 at the front of the front shell 12 that is roughly shaped and configured to receive therein the front portion of a horse's hoof. The side wall 16 of the front shell 12 may beneficially be formed of a resiliently flexible material, such as thermoplastic polyurethane (TPU). The sole plate 14 is also beneficially formed of a resiliently flexible material such as TPU, and may be formed or molded integrally with the side wall 16, although this is not necessarily essential. The sole plate 16 comprises a an upper plate 14a, generally shaped in the form of the base of a horse's hoof, and a bottom layer 14b (which may be formed of the same, or a different, resiliently flexible material as the sole plate 16) with a tread 20 defined on its bottom surface (when the hoof boot is oriented for normal use). The upper plate 14a and the bottom tread layer 14b may be integrally formed or molded, or they may be two separate layers adhered or fused together. The front portion of the tread layer 14b is angled upwardly toward the front of the peripheral side wall 16 to provide a break-over point 22. The upper plate 14a is substantially oval shaped along its front and side edges, but at the rear end (when the hoof boot is oriented for normal use) a first, generally V-shaped recess 24 is defined, with the apex of the ‘V’ extending toward the centre of the sole plate 14. Further, a second, generally (isosceles) triangular recess 26 is defined generally centrally in the sole pllate 14. Two pairs of arced drainage slots 28 is provided in the side wall 16, one pair on each side of the of the front shell 12, the two arced drainage slots 28 on each side of the front shell being in side by side, spaced apart relation. An aperture 30 is provided on each of side of the side wall 16, in the gap between a respective pair of drainage slots 28. Each of the apertures 30 is configured to permit the attachment of a first end of an attachment strap (not shown) to the front shell 12. The second end(s) of such anchor strap(s) can be connected to the side of the rear captivator 13 (to be described hereinafter) for increased mediolateral stability.

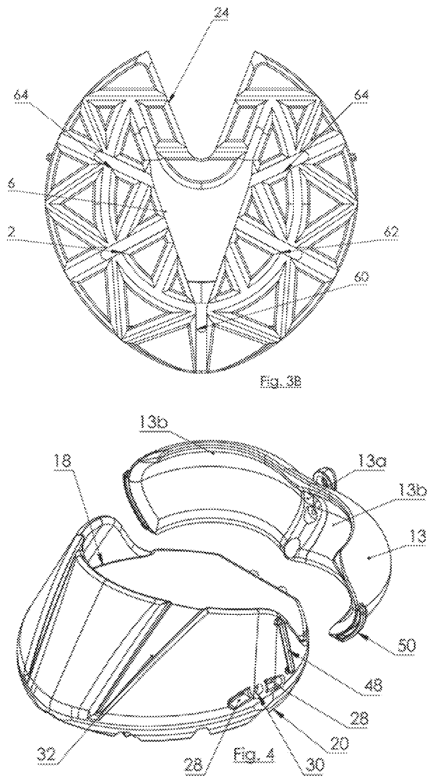

Referring particularly to FIGS. 1A and 3A, and additionally to FIGS. 1B and 3B, of the drawings, a pair of first slots 32 is provided at the front of the peripheral side wall 16, the first slots 32 being provided on either side of the centre of the front of the peripheral side wall 16. The first slots 32 are circumferentially spaced apart and substantially equally spaced from the centre of the front of the peripheral side wall 16. Each of the first slots 32 comprises a generally V-shaped channel or recess, which may extend all the way through the side wall 16, but may, more preferably, extend almost all the way through the side wall 16 leaving a thin film of the resiliently flexible material (nearest the outer surface of the peripheral side wall 16) to cover the recess. Each V-shaped channel or recess extends from a point close to the top of the peripheral side wall 16 to a point close to its lower edge, with the apex of the channel or recess 32 sitting adjacent to the upper edge of the sole plate 14. The resiliently flexible nature of the material sued to form the peripheral side wall 16 of the front shell 12 means that the first slots 32 allow the size of the recess 18, defined by the side wall 16, to be expanded or contracted by applying a generally radial force to the side wall 16. Thus, the V-shaped slots 32 allow the front shell 12 to, effectively, change size and shape to fit different shaped hooves. It will be appreciated that the slots 32 need not necessarily be V-shaped, but could instead be, for example, more of an elongate rectangular or oval shape, and they may not extend nearly all the way down the peripheral side wall 16, as in the illustrated example. In a preferred embodiment, the recesses forming the first slots 32 are generally V-shaped, extend to a depth of at least 2 mm through the peripheral side wall 16, and extend along most, if not all, of the height of the peripheral side wall 16 (to the upper edge of the upper plate 14a of the sole plate, but the present invention is not necessarily strictly limited in the regard.

Referring particularly to FIGS. 3A and 3B of the drawings, a plurality of second slots 60, 62, 64 are provided in the sole plate 14 (comprising the upper plate 14a and the tread layer 14b). The second slots 60, 62, 64 each extend from an edge of the central (triangular) recess 26, generally radially, along a portion of the sole plate 14, and may extend all the way through both layers 14a, 14b of the sole plate 14, but more preferably comprise recesses that extend almost all the way through the two layers 14a, 14b of the sole plate, leaving a thin film of the resiliently flexible material (nearest the bottom of the tread layer 14b). A first slot 60 is provided at the front (and centre) of the sole plate 14, adjacent to the apex of the second recess 26, and two pairs of slots 62, 64 extend from the side edges of the second recess 26 toward the sides of the side plate 14. A first pair of slots 62 is located generally centrally along the side edges of the second recess 26 (one on each side thereof) and a second pair of slots 64 is located close to the base of the second recess 26. These slots 60, 62, 64 enable the internal shape of the sole plate 14 to be altered according to the specific shape of a particular horse's hoof by flexing according to the force applied at the side edges by the horse's hoof. A typical horse's hoof will be generally round and is likely to have a diameter slightly wider than the widest points between the sides of the (generally) oval sole plate 14. Thus, when a horse's hoof is pushed into the recess 18 at the front of the front shell 12, it will cause the side walls 16 of the front shell to be pushed outwardly (expanding the recess 18), causing the sole plate 14 to flex. As a result, the front slot 60 will be widened, the first pair of slots 62 along the sides may widen a little, but the second pair of slots 64 (nearest the rear of the sole plate 14) will narrow to accommodate the widening of the other slots. The shape of the sole plate 14 is thus adjusted to fit a particular horse's hoof, and when the attachment straps (not shown) for connecting the heel captivator 13 to the front shell 12 (to be described hereinafter) are attached and tightened, the first slots 32 at the front of the peripheral side wall 16 will flex or contract to the shape of the upper part of the horse's hoof.

Referring now particularly to FIGS. 1A, 4, 5, 6 and 7 of the drawings, the heal captivator 13 comprises a generally C-shaped member, ergonomically shaped to fit over the heel of a horse's hoof. Thus, the C-shaped member has a central portion 13a, and an integral pair of heel bulb receiving portions 13b, each heel bulb receiving portion extending outwardly from the central portion 13a. Each heel bulb receiving portion 13b comprises a curved plate that, when oriented for normal use, is concave from the point of view of the front shell 12 of the hoof boot and thus slightly bulbous when viewed from the rear of the hoof boot. The top and bottom edges of each of each heel bulb receiving portion 13b is slightly curved inwardly (in the direction of the front shell 12 of the hoof boot when oriented for normal use). In use, the top edge of each heel bulb receiving portion 13b fits over the top of the radius of a respective heel bulb of a horse's hoof, which helps to prevent the hoof from raising up and coming out of the hoof boot during fast or vigorous exercise.

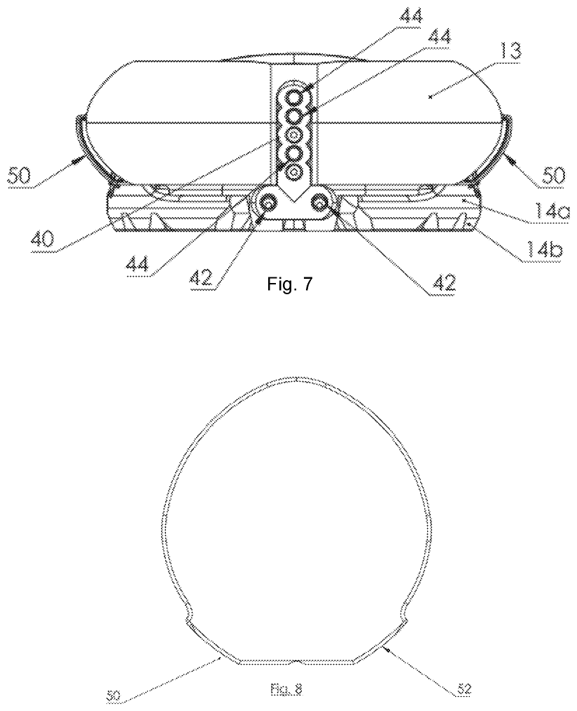

At the rear of the heel captivator 13, adjacent to the central portion 13a thereof, a central post 40 is provided. At the base of the central post 40, there is provided a pair of side-by-side first apertures 42, and a plurality of (at least two) longitudinally spaced-apart second apertures 44 is provided along its length. At the rear of the front shell 12, extending from the sole plate 14, there is provided a pair of side-by-side protruding members 46, each having a ball (or similar widening of diameter) at its distal end. In use, the heel captivator can be affixed to the sole plate 14 of the front shell 12 by pushing the first apertures 42 over the distal ends of the protruding members 46 (as shown in FIG. 7 of the drawings). A second protruding member (not shown) is provided at the rear of the heel captivator 13, located adjacent the central portion 13a thereof and around the centre of its height. Thus, the height of the heel captivator 13 relative to the sole plate 14 of the front shell 12 can be adjusted by selectively pushing one of the second apertures 44 over the second protruding member. Accordingly, the central post 40 not only serves to attach the heel captivator 13 to the front shell 12, but also provides limited free movement in terms of the height of the rear heel captivator 13 relative to the sole plate 14.

A first pair of strap loops 48 is provided on the outer surface of the peripheral side wall 16 of the front shell 12, each of the first pair of strap loops being located on a respective side of the front shell 12, near the rear thereof. A second pair of strap loops 50 is provided on the outer surface of the rear captivator 13, each of the second pair of strap loops 50 being located at a respective distal end of the heel captivator 13. In use, a pair of attachment straps (not shown) can be used to secure the heel captivator to the front shell and tighten he hoof boot around a horse's hoof. The attachment straps employ a three-point attachment system. Accordingly, a first end of each attachment strap can be connected to the side of the front shell 12 by means of a respective aperture 30 (located between the arced drainage slots 28), the strap can then be passed through the first pair of strap loops 48, then through the second pair of strap loops 50, and back to the front shell 12 where a fastener (not shown secures the second end of the strap to the front shell 12. The second pair of strap loops 50 may incorporate a roller or the like for ease in fitting the attachment straps and tightening them up to secure the hoof boot.

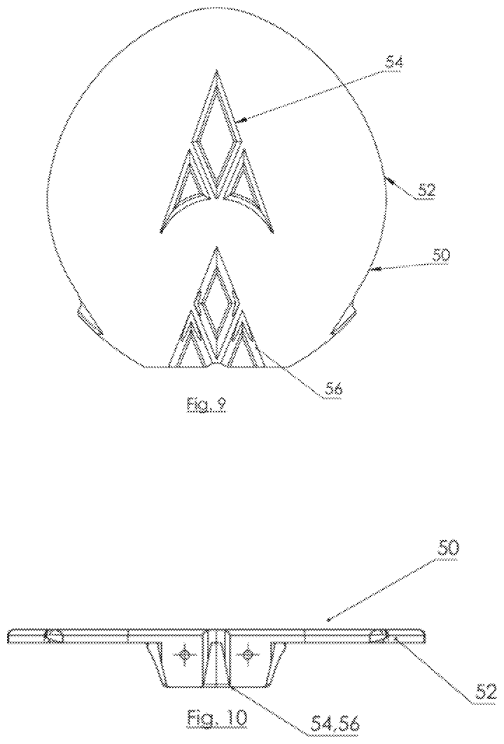

The hoof boot will, in use, also include an in-sole (not shown in FIGS. 1A to 7). Thus, referring to FIGS. 8 to 10 of the drawings, an in-sole 50 is provided, that comprises a substantially circular hoof plate 52 having a first, substantially planar surface and an opposing surface one which is provided a first protruding insert portion 54, of a shape and size substantially matching that of the opening 26 in the sole plate 14, and a second, triangular protruding insert portion 56 of a shape and size substantially matching the outer edge of the V-shaped frame portion 24. In use, a user would place their horse's hoof on the planar surface, draw around it, and then cut the hoof plate 52 to exactly match the shape of the bottom of the horse's hoof. The in-sole can then be mounted in the sole plate 14 by pushing the first protruding insert portion 54 into the generally triangular recess 26, with the second protruding insert portion 56 resting against the outer edge of the V-shaped frame portion 24, such that the back of the hoof plate 52 lies flush against the upper surface of the planar sole plate 14. The bottom surface of both the first and second protruding insert portions have a tread defined thereon that matches the tread on the underside of the sole plate 14.

Thus, the hoof boot described above allows, not just the (back to front) size of the hoof receiving recess to be adjusted, as in the prior art, but also allows the internal shape of the hoof-receiving recess to be adjusted to precisely fit a particular horse's hoof, thus mitigating the disadvantages described above associated with poorly fitting horse hoof boots.

It will be apparent to a person skilled in the art, from the foregoing description, that modifications and variations can be made to the described embodiments without departing from the scope of the invention as defined by the appended claims.

What is claimed is:

1. A hoof boot comprising a front shell and a removably attached heel captivator, the front shell comprising an upper portion defining a recess for receiving the front of a horse's hoof, in use, and the heel captivator being configured, in use, to retain and support the rear of a horse's hoof, the front shell further comprising a sole plate, said upper portion of the front shell being physically coupled to a portion of an outer edge of the sole plate, the sole plate and upper portion of the front shell being formed of a resiliently flexible material, wherein at least one first slot or recess is provided in the front shell, the or each first slot or recess extending from an upper edge of the upper portion and along at least a portion of its height, and the sole plate has at least two second slots or recesses therein, each second slot or recess extending generally radially from a central region of said sole plate along a at least a portion of a width thereof.

2. A hoof boot according to claim 1, wherein at least two first slots or recesses are provided in the front shell, each first slot or recess being located at the front of the upper portion, when oriented for normal use, and each first slot or recess being located at an equal distance from the centre thereof.

3. A hoof boot according to claim 1, wherein the or each first slot or recess is generally V-shaped, the widest end thereof being located at the upper edge of the upper portion of the front shell, and the apex thereof being located near an edge of the sole plate.

4. A hoof boot according to claim 1, wherein the front and side edges of the sole plate, when oriented for normal use, are substantially oval, and wherein the rear of the sole plate has a generally V-shaped recess therein, the widest end of said V-shaped recess being located at the outer edge of the sole plate.

5. A hoof boot according to claim 1, wherein the sole plate has a generally central opening or recess therein, defining said central region, and said at least two second slots or recesses extend generally radially from said opening along a portion of the width of the sole plate.

6. A hoof boot according to claim 5, wherein said central opening is generally triangular.

7. A hoof boot according to claim 1, wherein at least two pairs of second slots of recesses are provided in the sole plate, each slot or recess of a respective pair extending from a respective side of said central region along a portion of the width of the sole plate.

8. A hoof boot according to claim 1, wherein at least one of said second slots or recesses extends along the longitudinal axis of the sole plate.

9. A hoof boot according to claim 1, wherein a bottom surface of said sole plate is provided with a tread layer, said second slots or recesses extending through at least a portion of said tread layer.

10. A hoof boot according to claim 5, wherein said sole plate further comprises a removable in-sole comprising a hoof plate that has a first substantially planar surface and a protruding insert portion on the opposing second surface, said protruding insert portion being shaped and configured to fit into said generally central opening or recess in said sole plate.

11. A hoof boot according to claim 4, wherein said sole plate further comprises a removable in-sole comprising a hoof plate that has a first substantially planar surface and a protruding insert portion on the opposing second surface, said protruding insert portion being shaped and configured to fit into said V-shaped recess in said sole plate.

12. A hoof boot according to claim 10, wherein said in-sole is configured to be cut and/or trimmed to any desired shape or size prior to mounting it on said sole plate.

13. A hoof boot according to claim 1, wherein said heel captivator comprises a generally C-shaped heel cradle having a pair of distal ends, the heel cradle comprising a pair of side-by-side heel bulb receiving portions integrally coupled together by a central portion, each heel bulb receiving portion comprising a concave plate shaped and configured such that, in use, an upper edge thereof can engage with the radius of a respective heel bulb of a horse's hoof.

14. A hoof boot according to claim 13, further comprising a removably attached central post, wherein a protruding connecting member is provided at the rear of the heel captivator, at said central portion, said connecting member being configured to removably receive and retain an elongate central post via a first aperture along its length.

15. A hoof boot according to claim 14, wherein said central post comprises a plurality of first apertures along its length.

16. A hoof boot according to claim 14, wherein a pair of protruding connecting members is provided at the rear of the sole plate, and the central post comprises a pair of second apertures at its base for removably attaching said central post to the front shell via said connecting members.

17. A hoof boot according to claim 1, wherein said upper portion of said front shell and said heel captivator comprise means for receiving and retaining one or more attachment straps for coupling said heel captivator to said front shell, in use.
